(19) United States
(12) Patent Application Publication
(10) Pub. No.: US 2006/0245996 A1
(43) Pub. Date: Nov. 2, 2006

(54) Method of synthesizing single walled carbon nanotubes

(75) Inventors: Youchang Xie, Beijing (CN); Jixin Liu, Beijing (CN); Yuexiang Zhu, Beijing (CN)

Correspondence Address: PILLSBURY WINTHROP SHAW PITTMAN, LLP, P.O. BOX 10500, MCLEAN, VA, 22102, US

(73) Assignee: Peking University, Beijing (CN)

(21) Appl. No.: 11/115,405

(22) Filed: Apr. 27, 2005

(51) Int. Cl. C01B 31/02

(52) U.S. Cl. 423/445 R

(57) ABSTRACT

The present invention discloses a method of synthesizing single walled carbon nanotubes. Highly pure single walled carbon nanotubes is synthesized by the catalytic decomposition of carbon containing gases with Fe, Co, Ni, Mo and W catalysts in the presence of a small mount of water vapor, which can prohibit the generation of amorphous carbon and multi-walled carbon nanotubes on the surface of the catalysts and promote the generation of single-walled carbon nanotubes.

### BACKGROUND OF THE INVENTION

1. Technical Field

The present invention relates to nano-technologies, specifically, to a method of preparing highly pure single walled carbon nanotubes efficiently.

2. Description of Related Art

Ever since carbon nanotubes (CNTs) were discovered by Iijima in 1991, the researches on CNTs have been conducted extremely actively. CNTs are found to possess various unique advantageous properties, therefore, researches on CNTs have become one of the hottest fields of materials science in recent years. CNTs have a wide range of potential applications, including conductive and high strength composite materials, energy storing and converting devices (fuel cells), sensors, field emission display and transmitters, hydrogen storing materials, nano-semiconductor devices, microprobes and microleads.

CNTs can be categorized as multi-walled and single walled carbon nanotubes, and single walled carbon nanotubes (SWNTs) demonstrate superior properties than multi-walled carbon nanotubes (MWNTs) in many applications, e.g., the former have smaller diameter, less defects, higher strength and better conductive properties.

Currently, MWNTs with relative high purity can be produced massively with acceptable cost by decomposing under high temperature (from 600 to 1200° C.) from carbon-containing gases, such as methane, hydrocarbons with 2 to 8 carbon atoms, methanol, ethanol and CO etc. in the presence of catalysts containing transition metals such as Fe, Co, Ni and Mo etc. However, preparation of SWNTs is much more difficult. There is still lack of an efficient and cheap method for mass production of SWNTs, which constrains their extensive applications.

It was reported that SWNTs could be produced through carbon vaporization by laser (Thoss, A. et al., Science, 273: 483, 1996) and by arc discharging between graphite electrodes (Journet et al., Nature, 388:756, 1997). However, such method would give a product with coexistence of other types of carbon, and involve very high energy consumption and very low yield. Besides, such methods could not produce SWNTs continuously.

Catalytic decomposition is a promising method of producing SWNTs massively and cheaply. Dai et al. (Chemical Physics Letter, 1996, 260: 471) firstly reported SWNTs produced by catalytically decomposing CO under 1200° C. in a fixed bed of Al₂O₃ supported Mo catalyst. Unfortunately, this method requires very strict processing conditions, and only gives a product of relatively low purity with low yield. Cheng et al. (Applied Physics Letters, 1998, 72(25)3282) reported a method in which benzene is decomposed in 1100-1200° C. in a horizontal tubular bed with Fe catalyst and sulfide additives to form SWNTs. Also, this method suffers from low yield and low purity.

Smalley et al. reported in U.S. Pat. No. 6,692,717 that SWNTs were produced by reacting CO and ethylene as feed gas at a temperature from 800 to 850° C. in a tubular reactor in the presence of transition metal catalyst such as Fe and Mo supported on Al₂O₃ in a quartz boat. Again, the SWNTs were produced with low purity and a very low yield. Smalley et al. reported in U.S. Pat. No. 6,761,870 SWNTs were obtained by catalytically decomposing high pressure (about 30 atmospheric pressure) CO as raw gas at about 1000° C. in the presence unsupported metal nanoparticles obtained by pyrolyzing Fe(CO)₅, Ni(CO)₄, Fe(C₅H₅)₂ as catalyst precursor in a horizontal tubular reactor. Similarly this method only gave a product with low purity and low yield.

David Moy et al. reported in U.S. Pat. No. 6,827,919 a process in which molecules containing 1 to 6 carbon atoms used as raw material gas were catalytically decomposed to SWNTs in the presence of unsupported transition metal aerosol particles obtained by decomposing gases containing transition metal compounds. The resulted products contained SWNTs of a purity less than 50% and a large amount of amorphous carbon and MWNTs.

Resasco D. E. et al. reported in U.S. Pat. No. 6,333,016 a process in which SWNTs were obtained by catalytically decomposing carbon-containing gases such as CO in the presence of VIII group metals other than Fe such as Co, Ni and VIB group metals such as Mo supported on SiO₂. However, this process suffered from very low yield, and the purity of SWNTs is normally less than 90%.

Zheng Guobin et al. reported in CN1403371 a process for preparing SWNTs by reacting tetraethylorthosilicate and ferrocene entrained in a H₂-containing carrier gas at 900 to 1200° C. in a reactor. However, the used carbon containing raw gas is expensive, and the content of SiO₂ in products approximates 50%, which needs to be removed by HF to recover SWNTs, and the maximum yield of the process is only 8%.

Zhao Shetao et al. reported in CN1530321 SWNTs were synthesized by catalytically decomposing a mixture of methane and hydrogen in a tubular reactor at 700 to 1000° C. for about 1 h in the presence of rare earth and alkaline earth elements promoted Co, Mo supported on MgO or Al₂O₃ in a Mo boat. However, the process suffers from low space-time yield and too many multi-walled tubes in the product.

Zhu Hongwei et al. reported in CN1176014 that SWNTs as long as up to 20 cm could be obtained by catalytic decomposing a H₂ carried vaporized reaction solution containing n-hexane as carbon source and ferrocene catalyst and thiophene as additive in a vertical tubular reactor at 1000 to 1200° C. However, the single walled tubes were synthesized with a low purity, accounting for only about 5% of the products.

As can be seen from above prior art references, there are several problems regarding the preparation of SWNTs, i.e., low yield and low product purity, high manufacture cost. Accordingly, SWNTs cannot be cheaply produced and used on a large scale yet.

Our research group surprisingly found and reported in an article titled “Effect of Water on Preparation of Single-Walled Carbon Nanotubes (SWCNT) by Catalytic Decomposition of CH₄ in Ar”, (Ji-Xin, Zhao Ren, Lian-Yun Duan, You-Change Xie, Chemica Sinica 62(8), 775, 28 Apr., 2004) that SWNTs of very high purity could be obtained by addition of a small amount of water into methane which was catalytically decomposed in the presence of a catalyst containing transitional metals such as iron, molybdenum and tungsten at high temperatures. Kenji Hata et al reported, in a later published article entitled “Water-Assisted Highly Efficient Synthesis of Impurity-Free Single-Walled Carbon Nanotubes” (Science, 19 Nov., 2004, p.1362), that due to the effect of water to water-induced oxidation of amorphous carbon, high purity single-walled carbon nanotubes (SWCNTs) could be prepared via ethylene decomposition at 750° C. on Fe-containing catalysts using a carrier gas of Ar or He and H₂ containing a small amount of water vapor (20-500 ppm). However, as may be appreciated from our explanation as provided below, the effect of addition of water is significantly different from that of Kenji Hata et al. The role of water is not to oxidize the amorphous carbon formed by CH₄ decomposition, but rather to hinder the decomposition of CH₄ to form amorphous carbon on the surface of the catalysts (especially on the surface of the oxide-supports) and the surface of the quartz reactor.

This invention is fulfilled based on our above work.

### SUMMARY OF INVENTION

The object of present invention is to provide a method of synthesizing highly pure single walled carbon nanotubes which comprises reacting carbon containing gas under high temperatures in the presence of a catalyst, wherein, the synthesizing is carried out in the presence of water vapor. Said water vapor may originate from water or water precursor(s) that have been added into the carbon containing gas, in an amount effective to increase the purity of the produced single walled carbon nanotubes, preferably from 0.01 to 3 vol. % based on the volume of the carbon containing gas.

With water presented in the reaction, the present invention provides a process for producing SWCNT with high purity, i.e., the resulted product comprises predominately SWCNT, preferably the product consists essentially of SWCNT.

One advantage of the present invention is that SWCNT of higher purity than that of the relevant prior art method can be produced in a simple way with low cost.

### BRIEF DESCRIPTION OF DRAWINGS

The present invention will become more fully understood from the detailed description given herein below and the accompanying drawings which are given by way of illustration only, and thus are not limitative of the present invention and wherein

FIG. 1(a) is an electron microscopic image of reaction products when the carbon containing gas is not added with water in the example 1;

FIG. 1(b) is an electron microscopic image of reaction products when the carbon containing gas is added with water in the example 1;

FIG. 1(c) is an electron microscopic image of reaction products when the carbon containing gas is added with water in the example 2;

FIG. 1(d) is an electron microscopic image of reaction products when the carbon containing gas is added with water in the example 3;

FIG. 2(a) is an electron microscopic image of reaction products when the carbon containing gas is not added with water in the example 7;

FIG. 2(b) is an electron microscopic image of reaction products when the carbon containing gas is added with water in the example 7.

### DETAILED DESCRIPTION OF PREFERRED EMBODIMENTS

One object of present invention is to provide a method of synthesizing highly pure single walled carbon nanotubes which comprises reacting carbon containing gas under high temperatures in the presence of a catalyst, wherein, the synthesizing is carried out in the presence of water vapor in an amount effective to increase the purity of the produced single walled carbon nanotubes. In a preferable embodiment of present invention, a small amount of water is added into the carbon containing gas. When the carbon containing gas is decomposed into carbon products by a catalyst, such water can prevent the formation of amorphous carbon and MWNTs, thus promoting the purity of SWNTs. In another preferred embodiment, said water vapor is from water or water precursor(s) that have been added into the carbon containing gas, preferably in an amount of from 0.01 to 3 vol. % based on the volume of the carbon containing gas. Said water precursor(s) can produce water or water vapor before or during the reaction in the present process.

Preferably, the carbon containing gas is selected among molecules of 1 to 8 carbon atoms or the mixtures thereof, more preferably said carbon containing gas is methane. Said carbon containing gas may further include nitrogen, argon or hydrogen as carrier or dilute gas and sulfide as promoter.

The present process may be carried out at a temperature from 700 to 1200° C. The catalyst used in the present process can be those comprising transition metal(s) or alloy thereof particles. Said transition metals can be selected from Fe, Co, Ni or W. In a preferred embodiment, said catalyst is obtained by either heating and decomposing or reducing the transition metal compound(s) supported on a carrier of specific surface area selected from MgO, Al₂O₃ or SiO₂ or combinations thereof. In another preferred embodiment, said catalyst is obtained by either heating and decomposing or reducing the transition metal compound(s) in vapor phase in a reactor. The transition metal compound(s) can be, for example, oxides, chlorides, nitrates, sulfates, organic acid salts, carbonyl compounds, cyclopentadienyl compounds or acetylacetonates.

In the present process, a fluidized reactor, a floating catalyst reactor or a fixed-bed reactor can be used.

Other features and conditions may be determined by those skilled in the art according to the description, examples, figures disclosed herein.

The followings provide an analysis to the mechanism of the reaction taken place in the present process, but it is not intended to limit the present invention to it.

Most of the prior art catalytic decomposing methods used to prepare SWNTs generate simultaneously a considerable amount of amorphous carbon and MWNTs.

The conditions and principles for synthesizing SWNTs are attributed to the existence of particles of transition metals (Fe, Co, Ni, Mo, W) or alloys thereof which could catalyze and decompose the carbon containing gas, wherein the size of said particles can be about 1 to 3 nm, or bigger but influenced by additives (such as sulfides), and which can provide a metal surface area of about 1 to 3 nm. The carbon containing gas is catalyzed under high temperatures to decompose to produce carbon atoms on the surfaces of transition metal particles. The carbon atoms diffuse and dissolve into the metal particles, and precipitate on the metal surfaces after saturation in the metal, forming a cap of Fullerene-like structure with low energy. To lower energy, metal-carbon bonds will form on the perimeter of the cap. When more carbon atoms arrive, carbon atoms will grow upwards along the perimeter according to the graphite structure in order to reduce energy, thus forming SWNTs. Only SWNTs can grow on surfaces with a size less than about 3 nm of particles of transition metals or alloys thereof, if the carbon supplying speed of the decomposed carbon containing gas does not exceed the growth speed of SWNTs, which means that neither graphite nor amorphous carbon and MWNTs will grow. Though the graphite structure is stable, the bonding forces on the perimeter are unsaturated, and there are dangling bonds of very high bond energy, therefore, only if graphite pieces large enough were produced, rendering the energy increase due to the dangling bonds on the perimeter neglectable, the graphite structure could exist stably. It is difficult for the carbon atoms, which precipitate from the decomposed carbon containing gas on the small surfaces of transition metal particles, to form a stable graphite structure. The reason is that if graphite pieces grow to exceed the sizes of transition metal particles, metal-carbon bonds cannot be formed on the perimeter, and accordingly, dangling bonds on the perimeter cannot be removed to reduce energy. When the sizes of transition metal particles in the catalysts exceed 3 nm but are less than several tens nanometers, the carbon containing gas will generate MWNTs through high temperature catalysis and decomposition, while the graphite will not be generated. When the sizes of transition metal particles in the catalysts are too large (over several tens nanometers), the carbon containing gas tends to generate amorphous carbon on their surfaces through high temperature catalysis and decomposition. Amorphous carbon will be also formed, if the decomposition speed of the carbon containing gas under high temperature or the providing speed of the carbon atoms on the catalyst support surfaces and on the reactor surfaces exceeds the growth speed of MWNTs and SWNTs.

As can be seen from above analysis, SWNTs is a metastable form among the carbon allotropes. The generation of SWNTs is a combining process of dynamics control and structure control. It is possible to synthesize SWNTs efficiently by controlling appropriately the sizes of transition metal nano-particles in the catalysts, and selecting suitable process conditions.

It is found in the present invention that the carbon containing gas, which is added with a small amount of water, will produce highly pure SWNTs through high temperature catalysis and decomposition, in the presence of a catalyst comprising transition metals, such as Fe, Co, Ni, Mo and W. In contrast, dry carbon containing gas, which is not added with water, will produce under the same conditions amorphous carbon and MWNTs, with little SWNTs. It is also found in the experiments that, if water is added too much, no carbon containing products will be produced at all. In order to produce SWNTs, the amount of water needs to be added in a small amount. If computing according to the stoichiometry of the reaction, such amount of water is far less enough to remove the amorphous carbon produced by using dry raw material gas, according to the water gas reaction (C+H₂O→CO+H₂), indicating that the small amount of water is to prohibit the generation of amorphous carbon and MWNTs on the surface of the catalyst, and thereby to promote the generation of SWNTs. This may relate to the hydrolysis reaction of water on the surfaces of the transition metal particles, and the relatively strong interaction between the water and the surfaces of the catalyst support.

The substantial promotion effect of the added a small amount of water on the generation of SWNTs will be described according to the particular examples.

### EXAMPLE 1

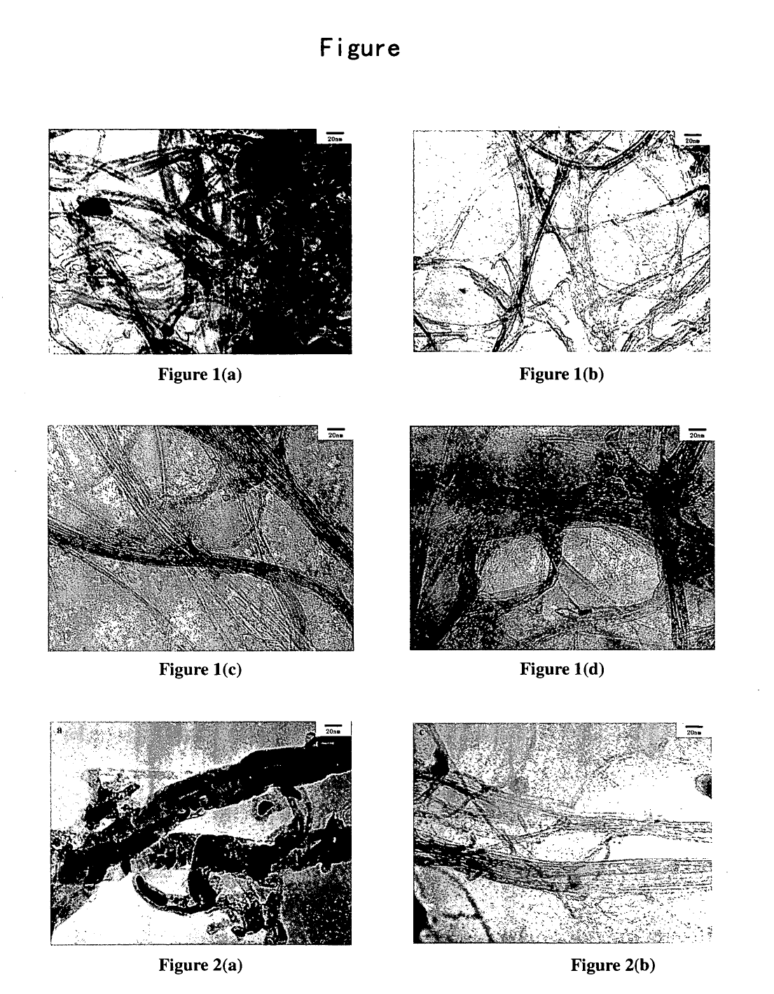

Ammonium molybdate, iron nitrate, magnesium nitrate and citric acid solution are mixed, followed by drying and calcination in the air at about 550° C. to give a composite oxide powder with an atomic ratio of Mo:Fe:Mg of 3:10:100, which is to be used as the precursor of the Mo—Fe—MgO catalyst. Into a small fluidized reactor (30 mm in diameter), 100 mg of the powders are put and then an Ar flow of about 150 ml/min is introduced. The temperature of the reactor is raised to about 1000° C., and then methane gas is introduced at about 45 ml/min. The reaction is allowed to proceed for about 30 minutes, and then the reactor is cooled to room temperature. The gross product is washed with HCl to remove MgO and most metals, further washed by water, and dried, and then a black powder product of 99 mg is obtained. By observing with an electron microscope, it reveals that most product are amorphous carbon and MWNTs as shown in FIG. 1(a). Contrary to expectation, under the same conditions as mentioned above except that water of 0.67 kPa partial pressure is added into the feed gas, we obtain a black product of 52 mg, which is highly pure SWNTs of 1 to 3 nm in diameters with amorphous carbon and MWNTs hardly observed, as shown in FIG. 1(b).

### EXAMPLE 2

Under the same conditions of example 1 except that water of 1.4 kPa partial pressure is added into the feed gas, 41 mg black product is obtained. The black product is highly pure SWNTs with amorphous carbon and MWNTs hardly observed, as shown in FIG. 1(c).

### EXAMPLE 3

Under the same conditions of example 1 except that water of 2.0 kPa partial pressure is added into the feed gas, 40 mg black product is obtained. The black product is highly pure SWNTs with amorphous carbon and MWNTs hardly observed, as shown in FIG. 1(d).

### EXAMPLE 4

Under the same conditions of example 1, but the adding water increases to 3.5 kPa partial pressure, no carbonaceous product can be found.

### EXAMPLE 5

Ammonium molybdate, iron nitrate, magnesium nitrate and citric acid solution are mixed and dried, then calcinated in the air at about 550° C. to give a composite oxide powder with an atomic ratio of Mo:Fe:Mg of 2:10:100, which is to be used as the precursor of the Mo—Fe—MgO catalyst. Into a small fluidized reactor (30 mm in diameter), 100 mg of the powders are put and then an Ar flow of about 150 ml/min is introduced. The temperature of the reactor is raised to about 1150° C., and then methane gas is introduced at about 45 ml/min. The reaction is allowed to proceed for about 30 minutes, and then the reactor is cooled to room temperature. The gross products are washed with HCl to remove MgO and most metals, further washed by water and dried, a black powder product of 110 mg is obtained. By observing with an electron microscope, it reveals that the product is amorphous carbon and MWNTs as shown in FIG. 1(a). Under the same conditions as mentioned above except that water of 1.4 kPa partial pressure is added into the feed gas, a black product of 55 mg is obtained. The product is highly pure SWNTs of 1 to 3 nm in diameter with amorphous carbon and MWNTs hardly observed, as shown by its electronic microscopic image.

### EXAMPLE 6

Ammonium molybdate, iron nitrate, magnesium nitrate and citric acid solution are mixed and dried, then calcinated in the air at about 550° C. to give a composite oxide powder with an atomic ratio of Mo:Fe:Mg of 2:10:100, which is to be used as the precursor of the Mo—Fe—MgO catalyst. Into a small fluidized reactor (30 mm in diameter), 100 mg of the powder is put and then an Ar flow of about 150 ml/min is introduced. The temperature of the reactor is raised to about 850° C., and then methane gas is introduced at about 45 ml/min. The reaction is allowed to proceed for about 30 minutes, and then the reactor is cooled to room temperature. The gross product is washed with HCl to remove MgO and most metals, further washed by water, and dried, a black powder product is obtained. By observing with an electron microscope, it reveals that the product is amorphous carbon and MWNTs as shown in FIG. 1(a). Under the same conditions as mentioned above except that water of 1.4 kPa partial pressure is added into the feed gas, the product becomes highly pure SWNTs of 1 to 3 nm in diameter with amorphous carbon and MWNTs hardly observed, as shown by its electronic microscopic image.

### EXAMPLE 7

Ammonium tungstate, iron nitrate, magnesium nitrate and citric acid solution are mixed and dried, then calcinated in the air at about 550° C. to give a composite oxide powder with an atomic ratio of W:Fe:Mg of 4:15:100, which is to be used as the precursor of the W—Fe—MgO catalyst. Into a small fluidized reactor (30 mm in diameter), 100 mg of the powder is put and an Ar flow of about 150 ml/min is introduced. The temperature of the reactor is raised to about 1000° C., and then methane gas is introduced at about 45 ml/min. The reaction is allowed to proceed for about 30 minutes, and then the reactor is cooled to room temperature. The gross product is washed with HCl to remove MgO and most metals, further washed by water and dried, then a black powder product is obtained. By observing with an electron microscope, it reveals that most products are amorphous carbon and MWNTs as shown in FIG. 2(a). Under the same conditions as mentioned above except that water of 1.4 kPa partial pressure is added into the feed gas, the product becomes highly pure SWNTs of 1 to 3 nm in diameter with amorphous carbon and MWNTs hardly observed, as shown by its electronic microscopic image FIG. 2(b).

### EXAMPLE 8

Solution of Ammonium molybdate and cobalt nitrate are used to impregnate silica gel and then dried and calcinated in the air at about 550° C. to decompose to get a composite oxide powder with a weight ratio of MoO₃:Co₂O₃:SiO₂ of 5:5:100. Putting 100 mg of the powder into a quartz boat, and further putting it into a tubular quartz reactor of 30 mm in diameter, an Ar flow of about 150 ml/min is introduced into the reactor, then the temperature of the reactor is raised to about 1200° C., and then ethylene gas as the carbon-containing gas is introduced at about 50 ml/min. The reaction is allowed to proceed for about 60 minutes, and then the reactor is cooled to room temperature. The gross product of carbon is washed with HF to remove SiO₂ and metal content, further washed by water and dried, a black powder is obtained. By observing with an electron microscope, it reveals that the product is amorphous carbon and MWNTs. Under the same conditions as mentioned above except that water of 1.0 kPa partial pressure is added into the feed gas, the product becomes highly pure SWNTs of 1 to 3 nm in diameter with amorphous carbon and MWNTs hardly observed, as shown by its electronic microscopic image.

### EXAMPLE 9

Solution of Ammonium molybdate and iron nitrate is used to impregnate silica gel and then dried, and calcinated in the air at about 550° C. to decompose to get a composite oxide powder with a weight ratio of MoO₃:Fe₂O₃:SiO₂ of 3:10:100. Putting 100 mg of the powder into a quartz boat, and further putting it into a quartz tubular reactor of 30 mm in diameter, an Ar flow of about 150 ml/min is introduced into the reactor, then the temperature of the reactor is raised to about 750° C., and then the Ar flow is substituted by hydrogen at about 50 ml/min and ethylene at about 50 ml/min. The reaction is allowed to proceed for about 60 minutes, and then the reactor is cooled to room temperature. The gross product is washed with HF to remove SiO₂ and metal content, further washed by water, and dried to recover a black powder. By observing with an electron microscope, it reveals that most products are amorphous carbon and MWNTs. Under the same conditions as mentioned above except that water of 1.0 kPa partial pressure is added into the feed gas, the product becomes highly pure SWNTs of 1 to 3 nm in diameter with amorphous carbon and MWNTs hardly observed, as shown by its electronic microscopic image.

### EXAMPLE 10

Solution of nickel nitrate and iron nitrate is used to impregnate alumina and then dried and calcinated in the air at about 550° C. to decompose to get a composite oxide powder with a weight ratio of NiO:Fe₂O₃:Al₂O₃ of 2:8:100. Putting 100 mg of the powder into a quartz boat, and further put it into a quartz tubular reactor of 30 mm in diameter, into which nitrogen is introduced at about 150 ml/min. The temperature of the reactor is raised to about 850° C., and then switch to hydrogen gas at about 100 ml/min and CO gas at about 100 ml/min. The reaction is allowed to proceed for about 60 minutes, and then the reactor is cooled to room temperature. The gross product is washed with NaOH first and then with HCl to remove Al₂O₃ and metal content, further washed by water, and dried, a black powder is obtained. By observing with an electron microscope, it reveals that most the product is amorphous carbon and MWNTs. Under the same conditions as mentioned above except that water of 1.0 kPa partial pressure is added into the feed gas, a black product is obtained. The product is highly pure SWNTs of 1 to 3 nm in diameter with amorphous carbon and MWNTs hardly observed, as shown by its electronic microscopic image.

### EXAMPLE 11

A vertical quartz reaction tube reactor of 40 mm in diameter is purged with nitrogen at 500 ml/min from upwards to downwards. The temperature of the reactor is raised to about 950° C., into which room temperature methane in room temperature comprising about 1 vol. % Fe(CO)₅ is introduced at about 10 ml/min. Fe(CO)₅ is therefore heated and decomposes into iron aerosol particles floating in the reactor. Simultaneously, methane preheated to about 950° C. is introduced at 300 ml/min. The methane decomposes on the surface of the iron catalyst, When the feed gas is added with about 1 vol. % water vapor, highly pure SWNTs of 1 to 3 nm is obtained. If the raw gas does not contain water, the product comprises a large amount of amorphous carbon and MWNTs under the same reaction conditions.

### EXAMPLE 12

A vertical quartz reaction tube reactor of 40 mm in diameter is purged with nitrogen at 500 ml/min from upwards to downwards. The temperature of the reactor is raised to about 1050° C., into which room temperature methane comprising about 1 vol. % cyclopentadienyl iron is introduced at about 10 ml/min. Cyclopentadienyl iron is therefore heated and decomposes into iron aerosol particles floating in the reactor. Simultaneously, methane preheated to about 1050° C. is introduced at 300 ml/min. The methane decomposes on the surface of the iron catalyst. The product is filtered and recovered. When the feed gas is added with about 0.3 vol. % water vapor, highly pure SWNTs of 1 to 3 nm is obtained. If the raw gas does not contain water, the product comprises a large amount of amorphous carbon and MWNTs under the same reaction conditions.

### EXAMPLE 13

A vertical quartz reaction tube reactor of 40 mm in diameter is purged with nitrogen at 500 ml/min from upwards to downwards. The temperature of the tube is raised to about 1050° C., into which hydrogen at room temperature comprising about 1 vol. % iron acetylacetonate is introduced to the reactor at about 10 ml/min. Iron acetylacetonate is therefore heated and decomposes to give iron aerosol particles floating in the reactor. Simultaneously, methane preheated to about 1050° C. is introduced at 500 ml/min. The methane decomposes on the surface of the iron catalyst. The product is filtered and recovered. When the feed gas is added with about 0.05 vol. % water vapor, highly pure SWNTs of 1 to 3 nm is obtained. If the raw gas does not contain water, the product comprises a large amount of amorphous carbon and MWNTs under the same reaction conditions.

### EXAMPLE 14

A vertical quartz reaction tube of 40 mm in diameter is purged with nitrogen at 500 ml/min from upwards to downwards. The temperature of the tube is raised to about 1050° C., into which methane at room temperature comprising about 1 vol. % FeCl₃ is introduced at about 10 ml/min. FeCl₃ is therefore heated and decomposes into iron aerosol particles floating in the reactor. Simultaneously, methane preheated to about 1050° C. is introduced at 500 ml/min. The methane decomposes on the surface of the iron catalyst. The product is filtered and recovered. When the raw gas is added with about 0.01 vol. % water vapor, highly pure SWNTs of 1 to 3 nm is obtained. If the raw gas does not contain water, the product comprises a large amount of amorphous carbon and MWNTs under the same reaction conditions.

### EXAMPLE 15

A vertical quartz reaction tube reactor of 40 mm in diameter is purged with nitrogen at 500 ml/min from upwards to downwards. The temperature of the reactor is raised to about 800° C., into which methane at room temperature comprising about 1 vol. % FeCl₃ is introduced into the reactor at about 10 ml/min. FeCl₃ is therefore heated and decomposes into iron aerosol particles floating in the reactor. Simultaneously, methane preheated to about 50° C. is introduced at 500 ml/min. The methane decomposes on the surface of the iron catalyst. The product is filtered and recovered. When the feed gas is added with about 0.02 vol. % water vapor, highly pure SWNTs of 1 to 3 nm is obtained. If the raw gas does not contain water, the product comprises a large amount of amorphous carbon and MWNTs under the same reaction conditions.

Further reference and disclosure is made herein by reference to Liu et al., “Effects of H₂O on Preparation of Single-wall Carbon Nanotubes (SWCNT) By Catalytic Decomposition of CH₄ in Ar,” Acta Chimica Sinica, Vol. 2, Apr. 28, 2004, No. 8, pp. 775-782, which is hereby incorporated by reference.

1. A process of synthesizing single walled carbon nanotubes comprising reacting carbon containing gas under high temperatures in the presence of a catalyst, characterized in that, the synthesizing is carried out in the presence of water vapor in an amount effective to increase the purity of the produced single walled carbon nanotubes.

2. A method of synthesizing single walled carbon nanotubes according to claim 1, characterized in that, said water vapor is from water or water precursor(s) that have been added into the carbon containing gas.

3. A method of synthesizing single walled carbon nanotubes according to claim 2, characterized in that, said water or water precursor(s) is added in an amount from 0.01 to 3 vol. % based on the volume of the carbon containing gas.

4. A method of synthesizing single walled carbon nanotubes according to claim 1, characterized in that, said carbon containing gas is selected among molecules of 1 to 8 carbon atoms or the mixtures thereof.

5. A method of synthesizing single walled carbon nanotubes according to claim 4, characterized in that, said carbon containing gas is methane.

6. A method of synthesizing single walled carbon nanotubes according to claim 5, characterized in that, said carbon containing gas might contain nitrogen, argon or hydrogen as dilute or carrier gas and sulfide as promoter.

7. A method of synthesizing single walled carbon nanotubes according to claim 1, characterized in that, the reaction is carried out at a temperature from 700 to 1200° C.

8. A method of synthesizing single walled carbon nanotubes according to claim 1, characterized in that, said catalyst comprises transition metal(s) or alloy thereof.

9. A method of synthesizing, single walled carbon nanotubes according to claim 8, characterized in that, said transition metals is selected from Fe, Co, Ni, Mo, W or their combinations.

10. A method of synthesizing single walled carbon nanotubes according to claim 9, characterized in that, said catalyst is obtained by either heating and decomposing or reducing the transition metal compound(s) supported on a carrier of high specific surface area selected from MgO, Al₂O₃ or SiO₂ or combinations thereof.

11. A method of synthesizing single walled carbon nanotubes according to claim 9, characterized in that, said catalyst is obtained by either heating and decomposing or reducing the transition metal compound(s) in vapor phase in a reactor.

12. A method of synthesizing single walled carbon nanotubes according to claim 10 or 11, characterized in that, said transition metal compound(s) is/are selected among oxides, chlorides, nitrates, sulfates, organic acid salts, carbonyl compounds, cyclopentadienyl compounds or acetylacetonates.

13. A method of synthesizing single walled carbon nanotubes according to claim 1, characterized in that, said reactor is a fluidized reactor, a floating catalyst reactor or a fixed bed reactor.
